(19) United States
(12) Patent Application Publication
(10) Pub. No.: US 2026/0213323 A1
(43) Pub. Date: Jul. 23, 2026

(54) BATTERY MODULE WITH SELECTABLE COMPRESSION AND PRESTRESSED STRUCTURAL FRAME

(71) Applicant: FCA US LLC, Auburn Hills, MI (US)

(72) Inventors: Bryan J. Macek, Auburn Hills, MI (US); Tae Kim, Auburn Hills, MI (US); Jill M. Koepfer, Auburn Hills, MI (US)

(21) Appl. No.: 19/033,870

(22) Filed: Jan. 22, 2025

(51) Int. Cl. H01M 50/244; H01M 50/211; H01M 50/224; H01M 50/227; H01M 50/231; H01M 50/242; H01M 50/262; H01M 50/291

(52) U.S. Cl. CPC H01M 50/244; H01M 50/211; H01M 50/224; H01M 50/227; H01M 50/231; H01M 50/242; H01M 50/262; H01M 50/291; H01M 2220/20

(57) ABSTRACT

A solid-state battery module and method of manufacturing the same is provided. The method includes providing a housing assembly having first and second endplates, a top panel and a bottom panel; providing a solid-state battery cell stack; arranging the first and second endplates against the solid-state battery cell stack; pre-compressing the solid-state battery cell stack with the first and second endplates; continuing to pre-compress the solid-state battery cell stack until a desired pressure is achieved; and joining, with the solid-state battery cell stack at the desired pressure, the top and bottom panels to the first and second endplates.

### FIELD

The present application relates generally to battery modules and, more particularly, to a compression housing assembly and method for manufacturing solid-state battery modules for electric vehicles.

### BACKGROUND

Solid state battery technology is a promising technology that could potentially replace conventional liquid electrolyte type batteries by providing improved battery performance with high energy density and improved thermal characteristics. To achieve such high performance, it is critical to maintain high compression between the solid electrolyte and the electrodes to mitigate any potential delamination or void issues that can potentially result in issues at the interface due to high resistance and propagation of dendrites. The desired compression, which may be an order of magnitude higher than any compression required of conventional liquid electrolyte batteries, is not achievable using existing module design approaches. Accordingly, while conventional liquid battery modules work well for their intended purpose, there is a desire for improvement in the relevant art.

### SUMMARY

In accordance with one example aspect of the invention, a method of manufacturing a solid-state battery module is provided. The method includes providing a housing assembly having first and second endplates, a top panel and a bottom panel; providing a solid-state battery cell stack; arranging the first and second endplates against the solid-state battery cell stack; pre-compressing the solid-state battery cell stack with the first and second endplates; continuing to pre-compress the solid-state battery cell stack until a desired pressure is achieved; and joining, with the solid-state battery cell stack at the desired pressure, the top and bottom panels to the first and second endplates.

In addition to the foregoing, pre-compressing the solid-state battery cell stack comprises: pre-compressing the solid-state battery cell stack with an assembly machine having at least one of a plurality of assembly rods and beams to a desired compression.

In addition to the foregoing, the method includes retracting, subsequent to the joining, the assembly machine.

In addition to the foregoing, the joining further comprises: clinching the top panel to the first endplate and the second endplate.

In additional implementations, clinching the top panel to the first endplate comprises: clinching the top panel to a top flange of the first endplate; and clinching the top panel to a top flange of the second endplate.

In additional implementations, the joining further comprises: clinching the bottom panel to the first endplate and the second endplate.

In additional implementations, clinching the bottom panel to the first endplate comprises clinching the bottom panel to a bottom flange of the first endplate; and clinching the bottom panel to a bottom flange of the second endplate.

In additional implementations, arranging the first and second endplates against the solid-state battery cell stack comprises: arranging a convex profile of the first and second endplates against the solid-state battery cell stack wherein a central portion of the convex profile is positioned closer to the solid-state battery cell stack.

In still other examples, the first endplate and the second endplate are integrally formed with the top and bottom panels.

In additional implementations, subsequent to joining the top and bottom panels to the first and second endplates, the first and second endplates attain a substantially straight profile.

In additional implementations, the method further includes: arranging spacer plates on opposite sides of the solid-state battery cell stack prior to the arranging of the first and second endplates.

In additional implementations, joining further comprises one of a resistance spot welding, a resistance projection welding and/or a hemming process.

In additional implementations, at least one of the first and second endplates, a top panel and a bottom panel are coated with a polymeric material.

In accordance with another example aspect of the invention, a solid-state battery module is provided. In one example, the solid-state battery module includes a housing assembly having first and second endplates, a top panel and a bottom panel; and a solid-state battery cell stack. The first and second endplates both define a convex profile having respective central portions positioned closer to the solid-state battery cell stack during assembly, wherein subsequent to joining the top and bottom panels to the first and second endplates, the first and second endplates attain a substantially straight profile.

In addition to the foregoing, the first and second endplates both comprise an integral stiffening feature.

In addition to the foregoing, the top and bottom panels are formed of aluminum.

In addition to the foregoing, the top and bottom panels are formed of aluminum.

In additional features, the first and second endplates are formed of aluminum.

In other features, the first and second endplates are formed of formed steel with a laminated fiber composite.

In additional features, the first and second endplates are formed of formed steel with an additional stiffening plate.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an example exploded view of a solid-state battery module in accordance with the principles of the present application;

FIG. 2 is another perspective view of a partially assembled solid-state battery module shown in FIG. 1, illustrating first and second opposing endplates compressing the solid-state battery cell stack prior to positioning of top and bottom plates in accordance with the principles of the present application;

FIG. 3 is another perspective view of a partially assembled solid-state battery module shown in FIG. 2, illustrating the positioning of the top and bottom plates subsequent to compression of the solid-state battery cell stack;

FIG. 4 is yet another perspective view of the partially assembled solid-state battery module shown in FIG. 3, subsequent to placement and attachment of the top and bottom plates to the respective endplates once the desired compression of the solid-state battery cell stack has been achieved (and shown without the solid-state battery cell stack) in accordance with the principles of the present application;

FIG. 5 is a sectional view of the assembled solid-state battery module taken along lines 5-5 of FIG. 4 and illustrating the endplate coupled to the top and bottom plates by an exemplary clinching process;

FIG. 6 is a detail view of a clinching joint created between the top plate and the endplate subsequent to the clinching process;

FIG. 7 illustrates a side profile (solid line) of an endplate constructed in accordance to the present disclosure with a concave profile prior to assembly and a side profile (dashed line) of a prior art linear endplate shown flexed due to nominal cell pressure after assembly;

FIG. 8 is another perspective view of a partially assembled solid-state battery module shown in FIG. 1, illustrating alternate first and second opposing "L-shaped" endplates compressing the solid-state battery cell stack prior to positioning of top and bottom plates in accordance with the principles of the present application;

FIG. 9 is another perspective view of a partially assembled solid-state battery module shown in FIG. 1, illustrating alternate first and second opposing endplates including a “U-shaped” case and a generally flat plate compressing the solid-state battery cell stack prior to positioning of top and bottom plates in accordance with the principles of the present application; and

FIG. 10 illustrates an example method of manufacturing the solid-state battery module, in accordance with the principles of the present application.

### DETAILED DESCRIPTION

According to the principles of the present application, systems and methods are described for a solid-state battery module. In one example, the solid-state battery module includes a housing assembly, a solid-state battery cell stack, and one or more spacer plates. The housing assembly includes opposing endplates that compress the solid-state battery cell stack during an assembly step. The opposing endplates can be compressed such as by assembly rods and beams to a desired compression. Once the desired compression is attained, the opposing endplates are joined to top and bottom plates thereby retaining the desired compression of the solid-state battery cell stack. In advantages, the pressure is controlled by the location of the endplates. In this regard, the cell stack is compressed by the endplates to a set pressure before the joints are made. A slip plane allows the joint to be executed at various positions defined by the desired pressure being attained, instead of the pressure being a result of the endplate position.

In examples, the opposing endplates are formed with a convex profile having a central portion positioned closer to the solid-state battery cell stack. In examples, the opposing endplates are curved toward the cell stack an amount substantially equal to the amount of curvature that the endplates will flex at nominal cell pressure. The final result is an endplate that is substantially straight while under pressure. The stiffness required by the endplates to maintain pressure is thereby reduced. Furthermore, the endplates act as springs, allowing cell expansion to be accommodated with limited pressure increase. Moreover, cell contraction is accommodated with limited pressure decrease.

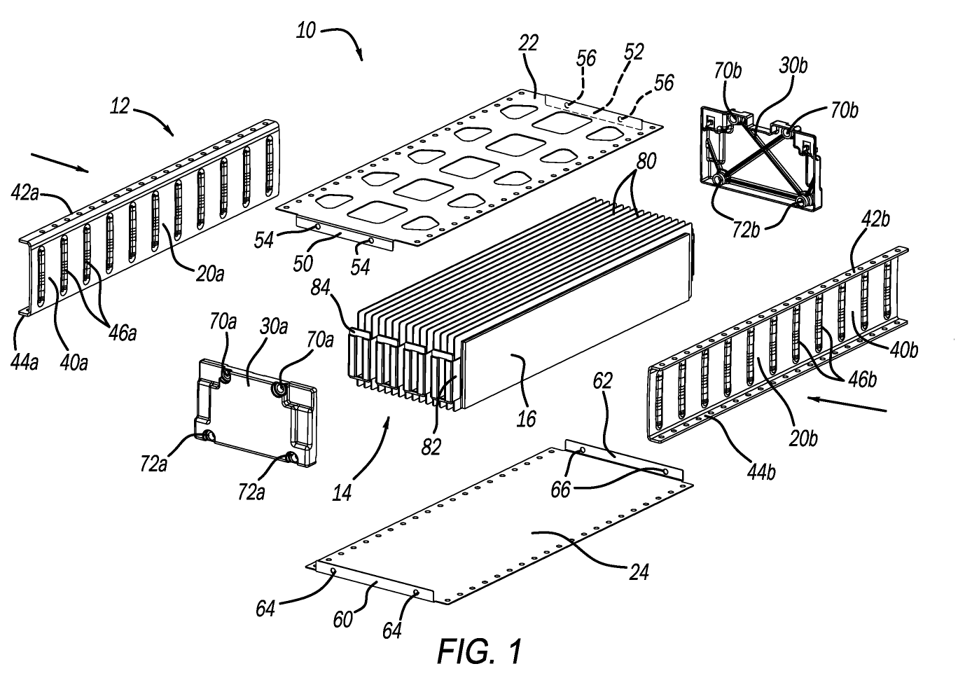

With initial reference to FIGS. 1-4, a solid-state battery module (SSBM) 10 is illustrated in accordance with the principles of the present disclosure. In the example embodiment, the SSBM 10 generally includes a housing assembly 12, a solid-state battery cell stack 14, and one or more spacer plates 16. The housing assembly generally includes a first and a second opposing endplate 20a and 20b, a top panel 22, a bottom panel 24, and a first and a second opposing cover plate 30a and 30b.

FIG. 1 illustrates the battery cell stack 14 and spacer plates 16 before compression and assembly relative to the housing 12 assembly. In examples, the components of the housing assembly 12 are fabricated from a rigid material (e.g., aluminum, steel, high strength composite, etc.), for example, via cold stamping, injection molding, or other suitable manufacturing process. As will be appreciated from the following discussion that endplates 20a, 20b are joined to the respective top and bottom panels 22 and 24 by a suitable joining process. The joining process described below is directed to a mechanical clinching process however other suitable joining process such as, but not limited to, self-piercing riveting or bolts, resistance spot resistance projection welding, and a hemming process. In advantages, such joining processes allow for the material to be pre-painted if desired for corrosion resistance and/or electrical resistivity. Such joining processes are considered cold processes that avoid the risk of heating the cells of the battery cell stack 14 and/or producing conductive metal flash or slag that can result from hot joining techniques such as, but not limited to, laser, resistance and arc welding.

In the example embodiment, the endplates 20a and 20b have a sufficient predefined thickness to enable housing assembly 12 to rigidly support a compressed battery cell stack 14 at a predefined final compression force. In one example, the endplates 20a and 20b each have a thickness of between 1.0 mm and 3.0 mm, or between approximately 1.0 mm and approximately 3.0 mm. However, it will be appreciated that endplates 20a and 20b may have any suitable thickness that enables SSBM 10 to function as described herein.

In the illustrated example, the endplate 20a includes a sidewall 40a, a top flange 42a and a bottom flange 44a. The sidewall 40a includes a series of ribs 46a defined thereon. The ribs 46a provide increased rigidity of the endplate 20a as a whole. The endplate 20b includes a sidewall 40b, a top flange 42b and a bottom flange 44b. The sidewall 40b includes a series of ribs 46b defined thereon. The ribs 46b provide increased rigidity of the endplate 20b as a whole.

The top panel 22 comprises a first flange 50 and a second flange 52. The first flange 50 defines first passages 54. The second flange 52 defines second passages 56. The bottom panel 24 comprises a first flange 60 and a second flange 62. The first flange 60 defines first passages 64. The second flange 62 defines second passages 66. The cover plate 30a includes upper bores 70a and lower bores 72a. The cover plate 30b includes upper bores 70b and lower bores 72b. In an assembled position, the first passages 54 of the top panel 22 align with the upper bores 70a of the cover plate 30a. Similarly, the second passages 56 of the top panel 22 align with the upper bores 70b of the cover plate 30b. The first passages 64 on the first flange 60 of the bottom panel 24 align with the lower bores 72a of the plate 30a. Similarly, the second passages 66 of the second flange 62 of the bottom panel 24 align with the lower bores 72b of the plate 30b. The aligned passages and bores accommodate fasteners (not specifically shown) in an assembled position. In some implementations, at least one of the first and second endplates 20a, 20b, the top panel 22 and the bottom panel 24 are coated with a polymeric material prior to assembly to provide electrical insulation.

With continued reference to FIG. 1, the solid-state battery cell stack 14 generally includes a plurality of cells 80 separated by compression pads 82. Each cell 80 can have various configurations known to those skilled in the art. For example, although not shown in detail, each single solid-state type cell 80 can generally include a solid-state separator (e.g., ceramic or solid polymer electrolyte) disposed between a first electrode (e.g., cathode) and a second electrode (e.g., anode). In one example, cell 80 may be lithium-ion and include an anode of pure lithium metal. Each compression pad 82 is configured to absorb contact stresses and provide protection between adjacent cells, as well as absorb cell thickness variation as the cells 80 charge (thicken) or discharge (thin). It will be appreciated that battery cell stack 14 can include any number of cells 80 in various arrangements. Moreover, the battery cells 80 are electrically connected in series, parallel, or combinations thereof. The battery cell stack 14 includes a plurality of tabs or terminals 84 to electrically connect the cells 60 or other stacks 14 (not shown).

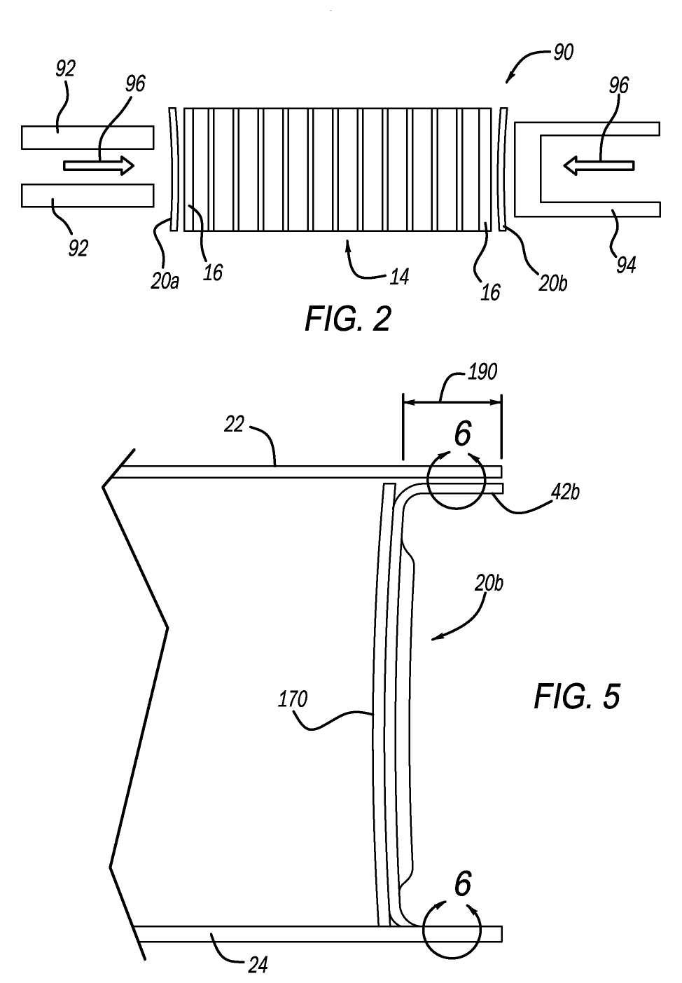

As shown in FIG. 1, spacer pads or plates 16 are disposed on opposite sides of the battery cell stack 14. In the example embodiment, the spacer plates 16 are configured to be contacted by the endplates 20a, 20b and assembly machine components when pre-compressing the battery cell stack 14, as described in more detail in FIG. 2. A thickness of each spacer plate 16 is chosen to provide a designed final compression (e.g., within a predefined tolerance) of battery cell stack 14 when disposed within the housing 12. For example, increasing spacer plate thickness will increase the final compression of the battery cell stack 14 and vice versa. Because the designed final compression of the battery cell stack 14 is more sensitive than traditional liquid electrolyte batteries, adjusting the spacer plate thickness enables the final compression to be tightly controlled in light of manufacturing variability and size and design adjustments. In this way, varying thicknesses may be chosen to accommodate manufacturing variability in cells 80, the compression pads 82, and/or the thickness of the components of the housing assembly 12.

With reference now to FIG. 5A, pre-compressing the battery cell stack 14 and spacer plates 16 with the endplates 20a and 20b is illustrated. FIG. 5A illustrates an end view of the housing 12, battery cell stack 14, spacer plates 16 and endplates 20a, 20b. In the example embodiment, the housing 12, battery cell stack 14, spacer plates 16, and endplates 20a, 20b are provided into an assembly machine 90 having one or more assembly rods 92 and/or assembly beams 94. The assembly rods/beams 92, 94 are then moved into contact with the endplates 20a, 20b (as shown by arrows 96) to squeeze and pre-compress the spacer plates 16 and battery cell stack 14 to a desired final compression. The assembly rods/beams 92, 94 are shaped to minimize local stress points, and as shown, multiple rods/beams may be deployed to spread the load on the endplates 20a, 20b.

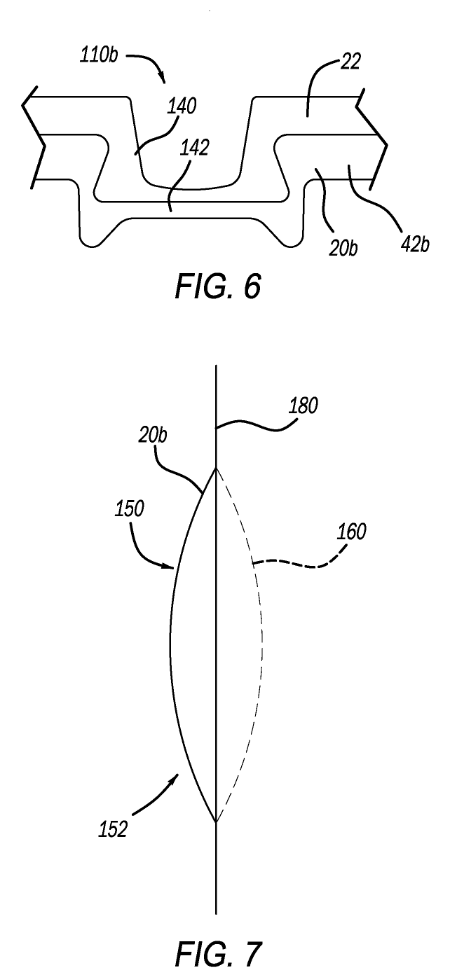

With additional reference now to FIG. 3, once the assembly rods/beams 92, 94 have attained the desired compressive force, with the assembly machine 90, the top panel 22 is advanced onto the flanges 42a and 42b of the respective endplates 20a and 20b. Similarly, the bottom panel 24 is advanced onto the flanges 44a and 44b of the respective endplates 20a and 20b. Notably, the battery cell stack 14 is still being compressed to the desired compression. Next, the top panel 22 is joined to the endplates 20a and 20b such as with a crimping operation (as is further described herein with respect to FIGS. 5 and 6). Additionally, the bottom panel 24 is joined to the endplates 20a and 20b such as with a crimping operation. It will be appreciated that the order of joining is arbitrary. In other words, the top panel 22 can be first secured, or the bottom plate can be first secured. Alternatively, the top and bottom panels 22 and 24 can be concurrently secured. The act of securing the top and bottom panels 22 and 24 causes the battery cell stack 14 to remain at the desired compression. Once the top and bottom panels 22 and 24 have been successfully attached to the endplates 20a, 20b, the assembly machine 90 need not apply compressive force and can be retracted.

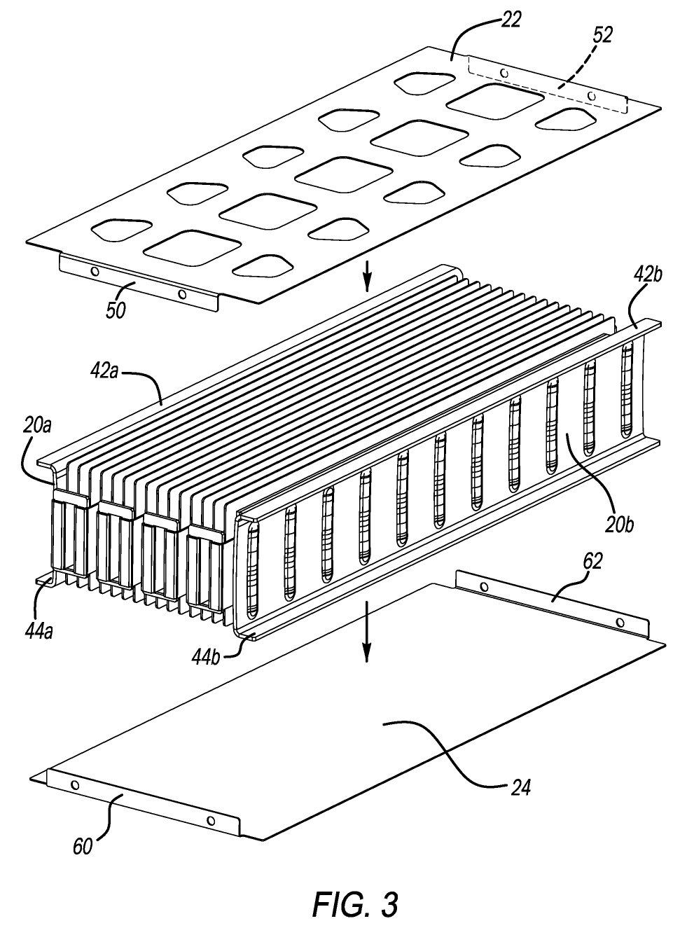

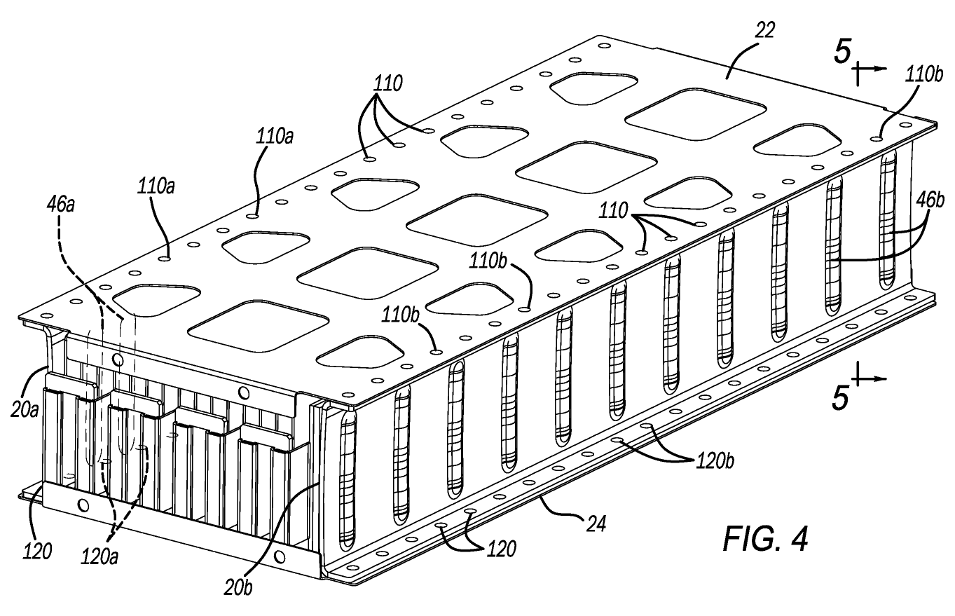

FIG. 4 illustrates the top panel 22 subsequent to being joined to the endplates 20a and 20b such as with a clinching operation. Additionally, the bottom panel 24 is shown subsequent to being joined to the endplates 20a and 20b such as with a clinching operation. In particular upper clinching joints 110 are shown formed at the top panel 22 and lower clinching joints 120 are shown formed at the bottom panel 24. Specifically, the upper clinching joints 110 include first upper clinching joints 110a that join the top panel 22 to the first endplate 20a and second upper clinching joints 110b that join the top panel 22 to the second endplate 20b. Similarly, the lower clinching joints 120 include first lower clinching joints 120a that join the lower plate 44 to the first endplate 20a and second lower clinching joints 120b that join the bottom panel 24 to the second endplate 20b.

FIG. 5 is a sectional view of the assembled solid-state battery module 10 taken along lines 5-5 of FIG. 4 and illustrating the endplate 20b coupled to the top and bottom panels 22 and 24 by an exemplary clinching process. For illustrative purposes, the flange 42b is shown before clinching to the top panel 22 and the bottom flange 44b is shown subsequent to clinching to the bottom panel 24. As described, the battery cell stack 14 is compressed by the endplates 20a, 20b to set a pressure before the joints (by way of the clinching) are made. A slip area can be defined at 190 that represents a lateral spacing from which the endplate can achieve a clinched (coupled) state relative to the top and bottom panels 22, 24. In other words, the endplates 20a and 20b can be secured at a wide range of positions along the slip area that corresponds to the desired pressure of the battery cell stack 14.

FIG. 6 is a detail view of a clinching joint created between the top plate and the endplate subsequent to the clinching process. In particular, the clinching joint 110b shown in FIG. 6 illustrates a clinched portion 140 of the top panel 22 and a clinched portion 142 of the endplate 20b deflected into a coupled position.

FIG. 7 illustrates a side profile (solid line) 150 of an endplate 20b constructed in accordance to the present disclosure with a concave profile 152 prior to assembly and a side profile (dashed line) 160 of a prior art linear endplate shown flexed due to nominal cell pressure after assembly. The endplate 20b (and optional metal stiffening plate insert 170, FIG. 5) are curved towards the cell stack 14 by an amount equal to the amount of curvature that the endplate 20b will flex at nominal cell pressure. This results in an endplate that will have a substantially flat or straight profile 180 while under pressure in the assembled position. This reduces the stiffness required by the endplate 20b to maintain pressure. Additionally, the wall acts as a spring, allowing cell expansion to be accommodated with limited pressure increase and cell contraction to be accommodated with limited pressure decrease. The concave profile 152 acts as an integral stiffening feature such that the curvature becomes approximately flat (profile 180) when set to a nominal pressure.

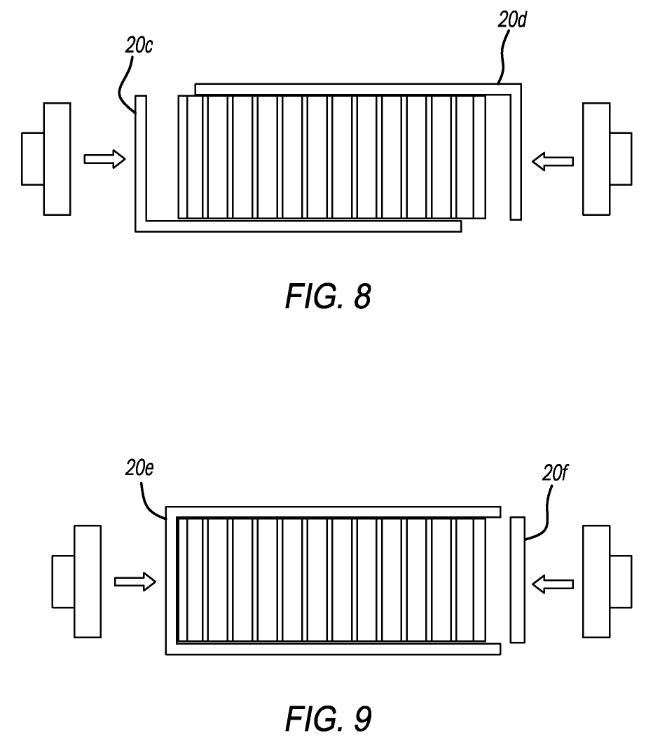

FIG. 8 is another perspective view of a partially assembled solid-state battery module shown in FIG. 1, illustrating alternate first and second opposing “L-shaped” endplates 20c and 20d compressing the solid-state battery cell stack prior to positioning of top and bottom plates in accordance with the principles of the present application. The cell stack is compressed with the L-shaped endplates 20c and 20d. Once the desired pressure is achieved the endplates 20c and 20d can be joined such as by clinching or hemming and/or coupled with adhesive. As shown, in the example of FIG. 8, the top and bottom panels are integrally formed with the respective endplates 20c, 20d.

FIG. 9 is another perspective view of a partially assembled solid-state battery module shown in FIG. 1, illustrating alternate first and second opposing endplates including a “U-shaped” case 20e and a generally flat plate 20f compressing the solid-state battery cell stack prior to positioning of top and bottom plates in accordance with the principles of the present application. The cell stack is compressed with the endplates 20e and 20f. Once the desired pressure is achieved the endplates 20e and 20f can be joined such as by clinching or hemming and/or coupled with adhesive. As shown, in the example of FIG. 9, the top and bottom panels are integrally formed with the endplate 20e.

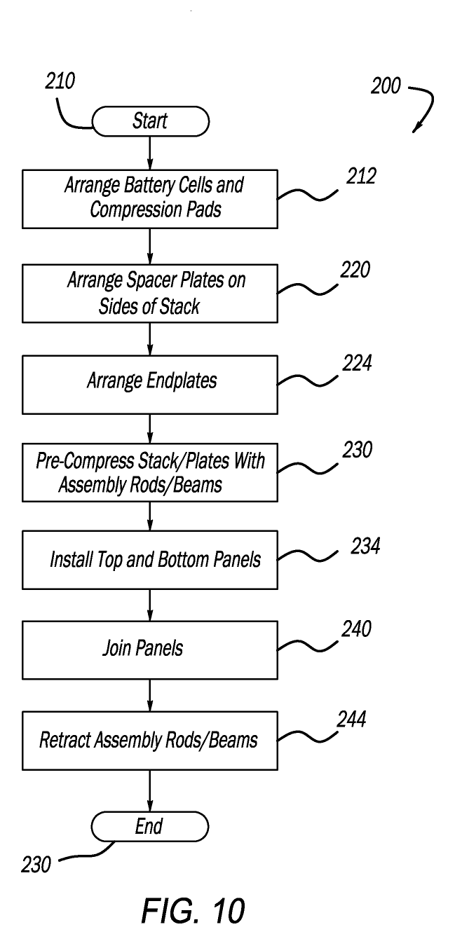

FIG. 10 illustrates an example method 200 of manufacturing the SSBM 10. The method 200 starts at step 202. At 212, the compression pads 62 are arranged between a plurality of cells 60 to form and provide solid-state battery cell stack 14. This step may be performed, for example, on an assembly table or assembly line. At step 220, one or more spacer plates 16 are provided and arranged on opposite sides of the battery cell stack 14. At step 224, the endplates 20a and 20b are arranged adjacent to the battery cell stack 14. At 230, the battery cell stack 14 and spacer plates 16 are pre-compressed utilizing assembly rods 92 and/or assembly beams 94. In one non-limiting example, the stack 14 is pre-compressed to and/or has a final compression of between 1.0 MPa and 3.0 MPa or between approximately 1.0 MPa and approximately 3.0 MPa. However, it will be appreciated that the battery cell stack 14 may have any suitable pre-compression or final compression to provide adequate interfacing between the cell stack components.

At step 234, the top and bottom panels 22 and 24 are installed. At 240 the top and bottom panels 22 and 24 are joined to the endplates 20a and 20b. At 244 the assembly rods 92 and/or assembly beams 94 are retracted. The method ends at 230.

Described herein are systems and methods for a solid-state battery module. Alternating battery cells and separator pads are arranged in a stack and spacer plates are arranged on opposite sides of the stack. Assembly rods/beams pre-compress the stack to enable a housing to be inserted over the pre-compressed stack. Top and bottom panels 22, 24 are attached to the endplates 20a, 20b once the desired pressure is achieved. Accordingly, the battery module 10 advantageously has very few parts and does not require any fasteners to attach housing components.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A method of manufacturing a solid-state battery module, comprising:
providing a housing assembly having first and second endplates, a top panel and a bottom panel;
providing a solid-state battery cell stack;
arranging the first and second endplates against the solid-state battery cell stack;
pre-compressing the solid-state battery cell stack with the first and second endplates;
continuing to pre-compress the solid-state battery cell stack until a desired pressure is achieved; and
joining, with the solid-state battery cell stack at the desired pressure, the top and bottom panels to the first and second endplates.

2. The method of claim 1, wherein the pre-compressing the solid-state battery cell stack comprises:
pre-compressing the solid-state battery cell stack with an assembly machine having at least one of a plurality of assembly rods and beams to a desired compression.

3. The method of claim 2, further comprising:
retracting, subsequent to the joining, the assembly machine.

4. The method of claim 1, wherein the joining further comprises:
clinching the top panel to the first endplate and the second endplate.

5. The method of claim 4, wherein clinching the top panel to the first endplate comprises:
clinching the top panel to a top flange of the first endplate; and
clinching the top panel to a top flange of the second endplate.

6. The method of claim 1, wherein the joining further comprises:
clinching the bottom panel to the first endplate and the second endplate.

7. The method of claim 6, wherein clinching the bottom panel to the first endplate comprises:
clinching the bottom panel to a bottom flange of the first endplate; and
clinching the bottom panel to a bottom flange of the second endplate.

8. The method of claim 1, wherein arranging the first and second endplates against the solid-state battery cell stack comprises:
arranging a convex profile of the first and second endplates against the solid-state battery cell stack wherein a central portion of the convex profile is positioned closer to the solid-state battery cell stack.

9. The method of claim 8 wherein, subsequent to joining the top and bottom panels to the first and second endplates, the first and second endplates attain a substantially straight profile.

10. The method of claim 1, wherein providing the housing assembly having the first and second endplates comprises:
providing a first endplate and a second endplate that are integrally formed with at least one of the top and bottom panels.

11. The method of claim 1, further comprising:
arranging spacer plates on opposite sides of the solid-state battery cell stack prior to the arranging of the first and second endplates.

12. The method of claim 1, wherein the joining further comprises one of a resistance spot welding, a resistance projection welding and a hemming process.

13. The method of claim 1, wherein at least one of the first and second endplates, a top panel and a bottom panel are coated with a polymeric material.

14. A solid-state battery module comprising:
a housing assembly having first and second endplates, a top panel and a bottom panel;
a solid-state battery cell stack; and
wherein the first and second endplates both define a convex profile having respective central portions positioned closer to the solid-state battery cell stack during assembly, wherein subsequent to joining the top and bottom panels to the first and second endplates, the first and second endplates attain a substantially straight profile.

15. The solid-state battery module of claim 14, wherein the first and second endplates both comprise an integral stiffening feature.

16. The solid-state battery module of claim 14, wherein the top and bottom panels are formed of aluminum.

17. The solid-state battery module of claim 16, wherein the aluminum comprises one of extruded aluminum and flat aluminum.

18. The solid-state battery module of claim 14, wherein the first and second endplates are formed of aluminum.

19. The solid-state battery module of claim 14, wherein the first and second endplates are formed of formed steel with a laminated fiber composite.

20. The solid-state battery module of claim 14, wherein the first and second endplates are formed of formed steel with an additional stiffening plate.
